(19) United States
(12) Patent Application Publication
(10) Pub. No.: US 2013/0282715 A1
(43) Pub. Date: Oct. 24, 2013

(54) METHOD AND APPARATUS OF PROVIDING MEDIA FILE FOR AUGMENTED REALITY SERVICE

(71) Applicant: SAMSUNG ELECTRONICS CO., LTD., Suwon-si (JP)

(72) Inventors: Yiling XU, Suwon-si (KR); Kyung-Mo PARK, Seoul (KR); Sung-Ryeul RHYU, Yongin-si (KR); Jae-Yeon SONG, Seoul (KR)

(73) Assignee: Samsung Electronics Co., Ltd., Suwon-si (JP)

(21) Appl. No.: 13/866,451

(22) Filed: Apr. 19, 2013

Related U.S. Application Data
(60) Provisional application No. 61/636,087, filed on Apr. 20, 2012.
(60) Provisional application No. 61/636,838, filed on Apr. 23, 2012.

(51) Int. Cl. G06F 17/30

(52) U.S. Cl. CPC G06F 17/30017
USPC 707/736

(57) ABSTRACT

A method and an apparatus of processing a media file for an Augmented Reality (AR) service are provided. The method includes storing a media file including information about an event to provide the AR service, and providing the media file. The information about the event includes identification information about an event item and information about an event type.

### CROSS-REFERENCE TO RELATED APPLICATIONS

This application claims the benefit under 35 U.S.C. §119(e) of a U.S. Provisional application filed on Apr. 20, 2012 in the U.S. Patent and Trademark Office and assigned Ser. No. 61/636,087 and a U.S. Provisional application filed on Apr. 23, 2012 in the U.S. Patent and Trademark Office and assigned Ser. No. 61/636,838, the entire disclosure of each of which is hereby incorporated by reference.

### BACKGROUND OF THE INVENTION

1. Field of the Invention

The present invention relates to processing of a data media file. More particularly, the present invention relates to a method and apparatus of providing a media file for an Augmented Reality (AR) service.

2. Description of the Related Art

AR is a view of virtual objects overlaid on objects of the real world that a user perceives. AR is also sometimes called mixed reality in that a virtual object or related information is combined with real-time audio/visual information, and thus an augmented information service can be provided, thereby expanding the senses and perception of human beings. Particularly, as mobile terminals and smart phones having various built-in sensors, such as a camera and a Global Positioning System (GPS), have recently become widespread, and a variety of convergence services using high-speed mobile Internet have emerged, the AR service using mobile devices has rapidly gained popularity.

The International Organization for Standardization (ISO) media file format defines a general structure for time-based multimedia files, such as video files and audio files. The ISO media file format forms the base of other file formats such as the MPEG-4 (MP4) and 3rd Generation Partnership Project (3GPP) file formats.

FIG. 1 illustrates the logical structure of an ISO media file according to the related art.

Referring to FIG. 1, a media file 100 includes a file header area 102, a metadata area 104, and a media data area 106.

The file header area 102 includes basic information about content contained in the media file 100. For example, a content Identifier (ID), a content creator, a creation time, or the like may be included in the file header area 102. If the media file 100 is divided into a plurality of tracks or streams, the file header area 102 may include map configuration information about the tracks.

The metadata area 104 includes information about each of a plurality of media objects in the content of the media file 100. The metadata area 104 includes information about the various profiles of, and positions of, the media objects in order to decode the media objects. A media object is a minimum unit of content. In a video, one image frame per unit time displayed on a screen may be a media object. In an audio track, one audio frame reproduced per unit time may be a media object. A plurality of media objects may exist in each track, and information needed to reproduce the media objects may be included in the metadata area 104.

The media data area 106 is an area in which the media objects are actually stored.

An ISO media file is physically configured as a set of related boxes. Each individual box includes related data and lower-layer boxes, or is a container box having lower-layer boxes only. For example, tracks illustrated in FIG. 1 are stored physically in track boxes. Each track box is a container box having various lower-layer boxes containing track header information, media information, and media decoding information.

The conventional ISO media file has specified neither meta information needed to provide an AR service, nor a method of combining multimedia content included in different layers, i.e., a signaling method of reproducing an image and a virtual object in an overlaid fashion. Accordingly, the conventional ISO media file has limitations in being used for the AR service.

Therefore, a need exists for a method and apparatus related to providing media files for Augmented Reality (AR) services.

The above information is presented as background information only to assist with an understanding of the present disclosure. No determination has been made, and no assertion is made, as to whether any of the above might be applicable as prior art with regard to the present invention

### SUMMARY OF THE INVENTION

Aspects of the present invention are to address at least the above-mentioned problems and/or disadvantages and to provide at least the advantages described below. Accordingly, an aspect of the present invention is to provide a method and apparatus of providing an Augmented Reality (AR) service using a media file.

Another aspect of the present invention is to provide a method and apparatus of providing a media file in order to provide an AR service.

Another further aspect of the present invention is to provide a method and apparatus of processing and reproducing a media file to provide an AR service.

In accordance with an aspect of the present invention, a method of processing a media file for an AR service is provided. The method includes storing a media file including information about an event to provide the AR service, and providing the media file, wherein the information about the event includes identification information about an event item and information about an event type.

In accordance with another aspect of the present invention, an apparatus for providing a media file for an AR service is provided. The apparatus includes a memory configured to store a media file including information about an event to provide the AR service, and a controller configured to provide the media file, wherein the information about the event includes identification information about an event item and information about an event type.

In accordance with another aspect of the present invention, a method of processing a media file for an AR service is provided. The method includes analyzing a media file including information about an event to provide the AR service, generating image data needed for image reproduction and reproducing the image data by extracting video or audio data from the media file, extracting event information from the media file, upon selection of the event, extracting an event item based on identification information about the item and information about an event type included in the event information, configuring an event image corresponding to the event item, combining the event image with the image data, and reproducing the combination.

In accordance with a further aspect of the present invention, an apparatus for processing a media file for an AR service is provided. The apparatus includes a media file analyzer configured to analyze a media file including information about an event to provide the AR service, a video player configured to generate image data needed for image reproduction and reproduce the image data by extracting video or audio data from the media file, an event player configured to extract event information from the media file, upon selection of the event, extract an event item based on identification information about the item and information about an event type included in the event information, and generate event image data corresponding to the event item, and an image combiner configured to combine the image data and the event image data and reproduce the combination, depending on whether the event is selected.

In accordance with another aspect of the present invention, at least one non-transitory processor readable medium for storing a computer program of instructions is provided. The at least one non-transitory processor readable medium for storing a computer program of instructions configured to be readable by at least one processor for instructing the at least one processor to execute a computer process for performing the methods claimed herein.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates the logical configuration of a conventional International Organization for Standardization (ISO) media file according to the related art;

FIG. 2 is a block diagram of a medial file reproduction apparatus that supports an extension part of an ISO media file format according to an exemplary embodiment of the present invention;

FIGS. 3A to 3C illustrate a case where an augmented event regarding a math problem is provided according to an exemplary embodiment of the present invention;

FIGS. 4A to 4C illustrate a case where an augmented event to change the resolution of a screen is provided according to an exemplary embodiment of the present invention;

FIGS. 5A to 5C illustrate a case where an augmented event is provided in a travel program according to an exemplary embodiment of the present invention;

FIG. 6 is a flowchart illustrating a procedure of reproducing a media file to provide an augmented service according to an exemplary embodiment of the present invention; and

FIG. 7 illustrates an ISO media file format that provides an augmented event for Augmented Reality (AR) according to an exemplary embodiment of the present invention.

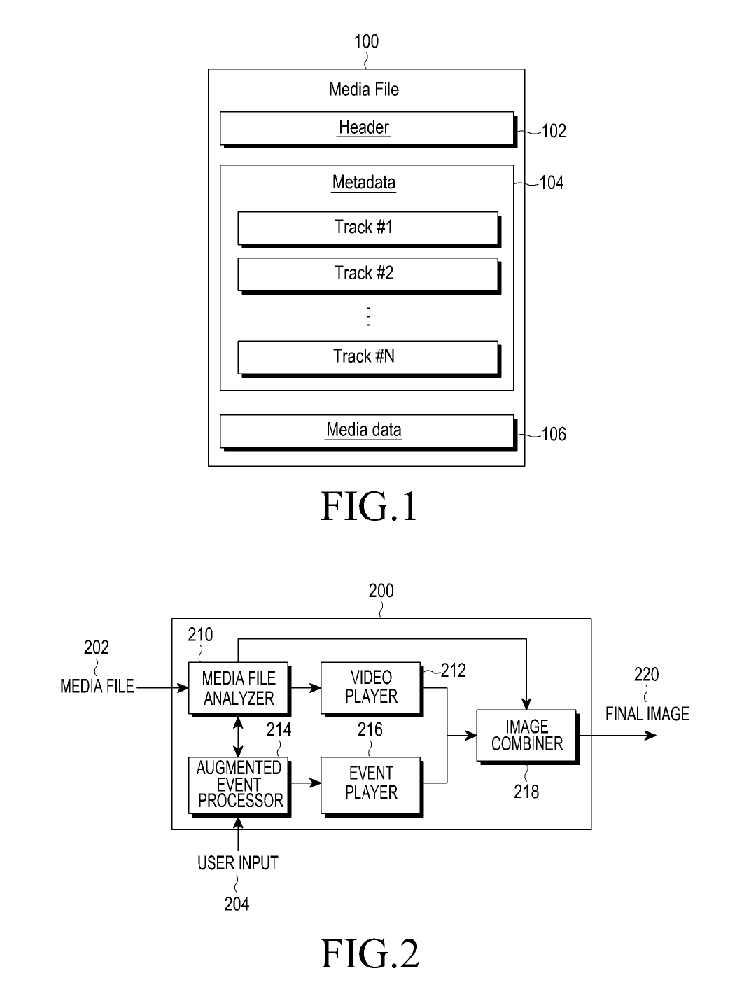

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A description will be given of an extension part of an International Organization for Standardization (ISO) media file format, which stores meta information needed to provide an Augmented Reality (AR) service in an ISO media file, and an apparatus to reproduce a media file formed in the ISO media file format.

FIG. 2 is a block diagram of a media file reproduction apparatus that supports an extension part of an ISO media file format according to an exemplary embodiment of the present invention. A media file reproduction apparatus 200 may be provided in a receiver configured to process a media file and provide an AR service.

Referring to FIG. 2, a media file analyzer 210 extracts various pieces of information required to reproduce a media file, including meta information necessary for providing the AR service, by analyzing a media file 202. An augmented event processor 214 activates or deactivates an event that provides the AR service based on a user input 204. A video player 212 generates final data needed for image reproduction by extracting video/audio data from the media file 202 and processing the extracted video/audio data. Similarly, an event player 216 generates final data used to display an event item (i.e. an AR object) on a screen (not shown) by extracting event information from the media file 202 and processing the extracted event information. An image combiner 218 configures a final image 220 by combining the image and event data to be displayed on the screen, received from the video player 212 and the event player 216 and reproduces the final image 220 on the screen. More particularly, the image combiner 218 determines the relationship between an image and an event item, that is, whether to reproduce the image and the event item in an overlapped manner or to produce only one of the image and the event item, in conjunction with the media file analyzer 210.

While not shown, an exemplary embodiment of the present invention provides a media file providing apparatus (e.g. a media file server) that stores and provides a media file of an ISO media file format according to an exemplary embodiment of the present invention to a receiver or an intermediate device that processes and reproduces the media file.

Methods of providing an AR service according to exemplary embodiments of the present invention will be described below.

In an exemplary embodiment of the present invention, a video show may help a user to solve a difficult math problem. That is, when the user has difficulty in reading and understanding a math problem displayed on a screen, the user may obtain a detailed stepwise description of how to solve the math problem by a video show by selecting, e.g., an event labeled “analyze the question by video show” on the screen.

In another example, when the user intends to change the resolution of a current screen while viewing one image or video frame of a file, the user may change the resolution of the current screen by selecting an event labeled “change resolution” displayed together with the image or frame on the screen.

In another exemplary embodiment of the present invention, when the user is interested in a character or object (e.g., a character or building in a cartoon) displayed on a screen while viewing a video, and thus wants to take a close look at the character or object three-dimensionally, the user may select an event labeled “display 3D” displayed on the screen.

In a further exemplary embodiment of the present invention, when the user wants to acquire additional information about a specific location while viewing a travel information program, the user may select an event labeled “advertisement” displayed on a screen.

In this manner, the user may select an augmented event related to an item displayed together with a currently reproduced item on a screen. Therefore, an exemplary embodiment of the present invention provides a file format that provides such an augmented event.

To provide an augmented event regarding an item, event-related information should be added to a file format. In an exemplary embodiment of the present invention, an event information (einf) box providing event-related information is further included in a meta box in addition to an item location (iloc) box indicating the position of an item and an information (inf) box providing information about the item.

Table 1 below illustrates a syntax including an event information box according to an exemplary embodiment of the present invention.

TABLE 1

```
aligned(8) class ItemInfoEntry extends FullBox(‘itie’, version, 0) {
  unsigned int(16) item_ID;
  unsigned int(16) event_count;
  for (i=1;i<=event_count;i++){
    string event_name;
    string event_description; //optional
    unsigned int(16) refer_item_ID; //optional
    unsigned int(16) event_data_reference_index; //optional
    unsigned int(32) event_relation_type; //optional
    }
}
    aligned(8) class ItemInfoBox
                  extends FullBox(‘einf’, version = 0, 0) {
            unsigned int(16) entry_count;
            EventInfoEntry[ entry_count ] event_infos;
}
```

In Table 1, parameters have the following meanings.

The parameter item_id is the Identifier (ID) of an item for which event information is defined.

The parameter event_count is the number of entries. Each item may have one or more events and each entry is used for one event of one item.

The parameter event_name is a Unicode Transformation Format (UTF)-8 null-terminated string including the name of an event for the item.

The parameter event_description provides an additional description of the event, when needed. For example, resolution parameters for an image may be enumerated in event_description.

The parameter refer_item_ID is the ID of an item that transfers a motion triggered by the event. For example, the item may be a high-resolution image or a three-dimensional (3D) image of a cartoon character in a file. If event content is provided by different items in the same file, the event content may be distinguished by item IDs.

The parameter event_data reference_index is an integer value including the index of a data reference used to search for event-related data when event content is provided by another file.

The parameter event_relation_type is a value describing the relationship between an original item and an event-related item indicated by refer_item_ID or event_data reference_index, set to one of ‘replace’ and ‘combine’. ‘Replace’ indicates replacement of the original item included in a file with a referred item, and ‘combine’ indicates displaying the original item and the event-related content together.

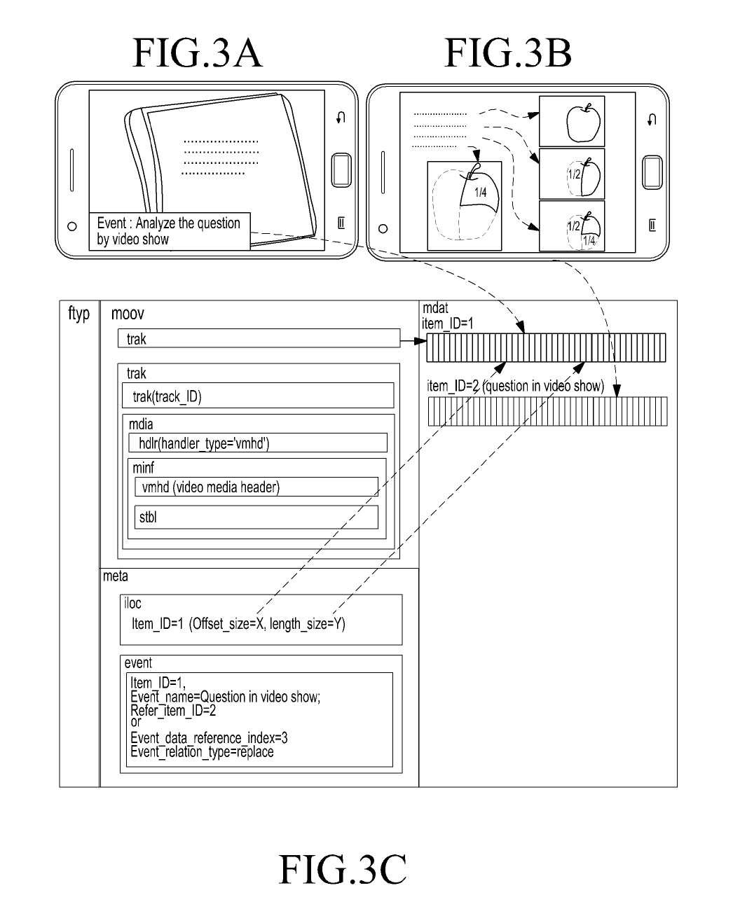

FIGS. 3A to 3C illustrate a case where an augmented event regarding a math problem is provided according to an exemplary embodiment of the present invention.

Referring to FIGS. 3A and 3B, when the user has difficulty in solving a math problem, the user may click on an augmented event labeled ‘analyze the question by video show’ displayed on a screen as shown in FIG. 3A. Then, the current screen is switched to a screen illustrated in FIG. 3B and the math problem is sequentially analyzed stepwise. In this manner, the user may understand and solve the math problem.

FIG. 3C illustrates the configuration of a file format including a meta box for the augmented event that provides the screen of FIG. 3B according to an exemplary embodiment of the present invention.

Referring to FIG. 3C, information about a position at which an original item is to be displayed is included in an iloc box and information about an event item related to the original item is included in an event box. Specifically, the ID of the original item including an event is 1 and the name of the event is ‘Question in video show’. If the original item and the event item are included in the same file, the ID (refer_item_ID) of an event item referred to by the event is included in the event box. On the other hand, if the original item and the event item are provided in different files, event_data_reference_index is included in the event box. Since the screen of the original item is replaced with the screen of the event item in FIG. 3B, event_relation_type is ‘replace’ and it is noted from an mdat box that the file with item_ID=1 indicating the original item and the file with item_ID=2 indicating the event item have the same length.

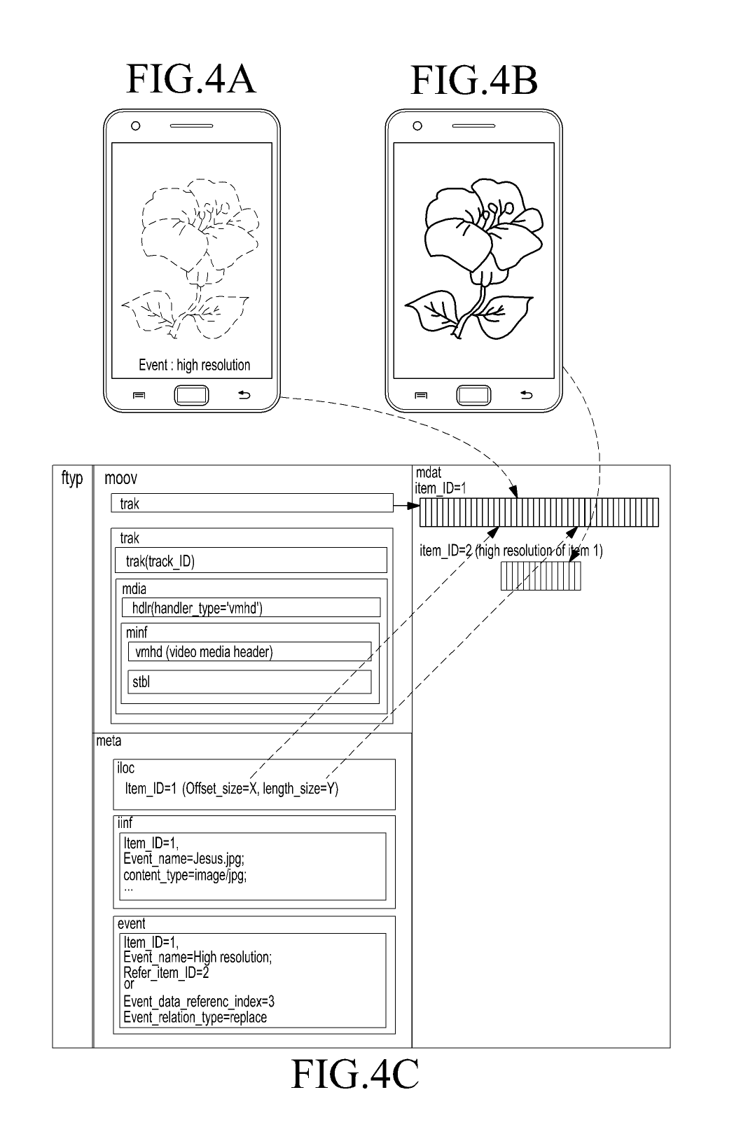

FIGS. 4A to 4C illustrate a case where an augmented event is provided to change the resolution of a screen according to an exemplary embodiment of the present invention.

Referring to FIGS. 4A and 4B, when the user wants to increase the resolution of an image during viewing the image with a standard resolution, the user may click on an augmented event ‘high resolution’ displayed on a screen as shown in FIG. 4A. Then, the current screen is switched to a screen illustrated in FIG. 4B and an image with a higher resolution than the original image is displayed on the screen.

FIG. 4C illustrates the configuration of a file format including a meta box for the augmented event that provides the screen of FIG. 4B according to an exemplary embodiment of the present invention.

Referring to FIG. 4C, information about a position at which an original item is to be displayed is included in an iloc box and information about an event item related to the original item is included in an event box. Specifically, the ID of the original item including an event is 1 and the name of the event is ‘High resolution’. If the original item and the event item are included in the same file, the ID (refer_item_ID) of an event item referred to by the event is included in the event box. On the other hand, if the original item and the event item are provided in different files, event_data_reference_index is included in the event box. Since the screen of the original item is replaced with the screen of the event item in FIG. 4B, event_relation_type is ‘replace’. Since only the image of a part of the original item is replaced with the event item during reproduction of the original item, the file with item_ID=1 indicating the original item is longer than the file with item_ID=2 indicating the event item in an mdata box.

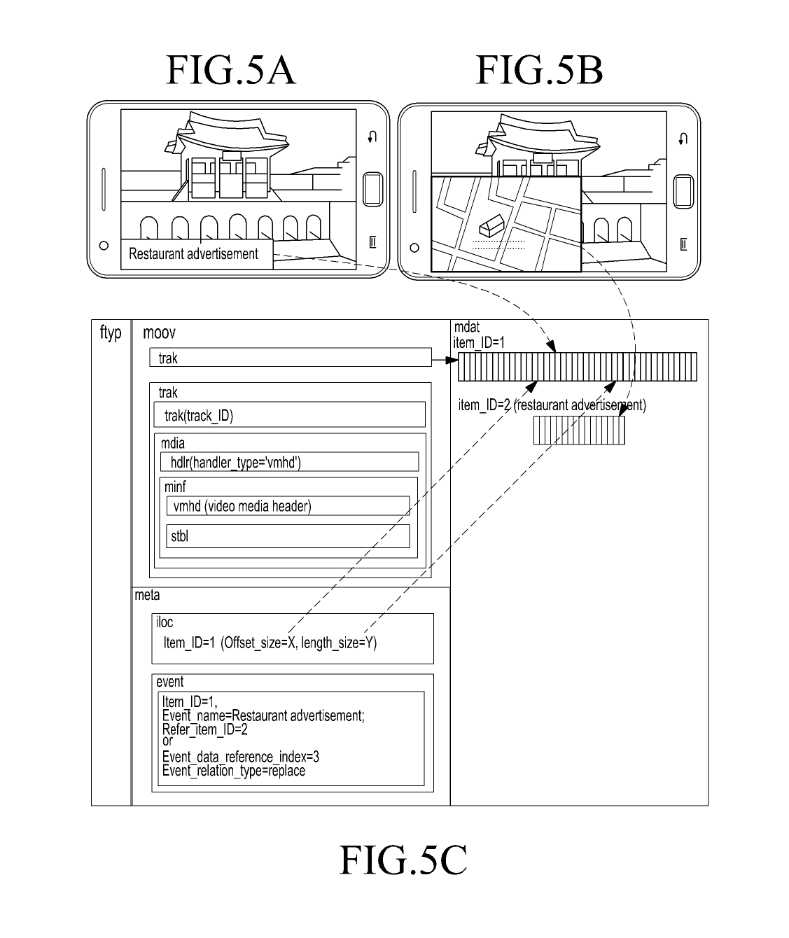

FIGS. 5A to 5C illustrate a case where an augmented event is provided in a travel program according to an exemplary embodiment of the present invention.

Referring to FIG. 5A, when the user wants to acquire information about local restaurants during the viewing of content that provides travel information, the user may click on an augmented event labeled ‘Restaurant advertisement’ displayed on a screen. Then, information about local restaurants is added to an original image, as illustrated in FIG. 5B.

FIG. 5C illustrates the configuration of a file format including a meta box for the augmented event that provides the screens of FIGS. 5A and 5B according to an exemplary embodiment of the present invention.

Referring to FIG. 5C, information about a position at which an original item is to be displayed is included in an iloc box and information about an event item related to the original item is included in an event box. Specifically, the ID of the original item including an event is 1 and the name of the event is ‘Restaurant advertisement’. If the original item and the event item are included in the same file, the ID (refer_item_ID) of an event item referred to by the event is included in the event box. On the other hand, if the original item and the event item are provided in different files, event_data_reference_index is included in the event box. Since the event item is added to the original item in FIG. 5B, event_relation_type is ‘combine’. Since the event item is reproduced along with the original item during reproduction of the original item in progress, it is indicated in an mdata box that the file with item_ID=1 indicating the original item is longer than the file with item_ID=2 indicating the event item.

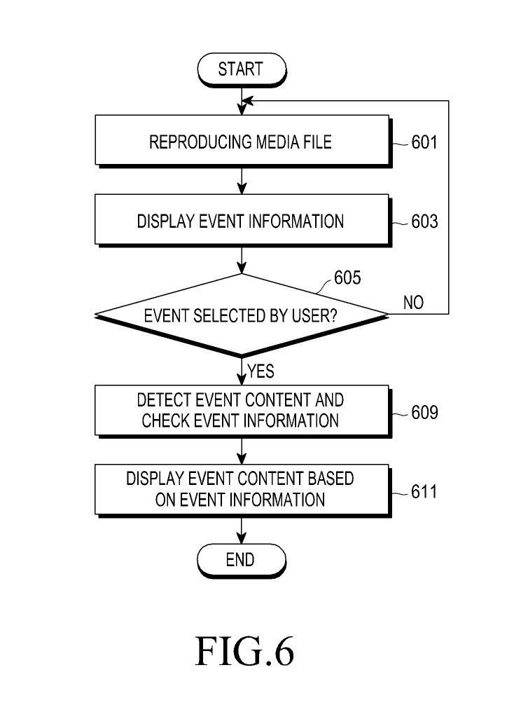

FIG. 6 is a flowchart illustrating a procedure of reproducing a media file to provide an augmented service according to an exemplary embodiment of the present invention.

Referring to FIG. 6, while the media file reproduction apparatus is reproducing a media file in step 601, it displays the name and description of an event related to the on-going media file in step 603. Upon selection of the event by a user input in step 605, the media file reproduction apparatus searches for an event item related to the selected event based on refer_item_ID or event_data_reference_index and checks event information about the detected event item in step 609. In step 611, the media file reproduction apparatus displays event content according to the event information. That is, if event_relation_type is ‘replace’, the event item may be displayed instead of the on-going media file. After the event ends, the user may end the original media file or resume the original media file, starting from the time point of selecting the event. If event_relation_type is ‘combine’, the event item is displayed along with the on-going media file. After the event is terminated, the original media file is continuously displayed without the event item.

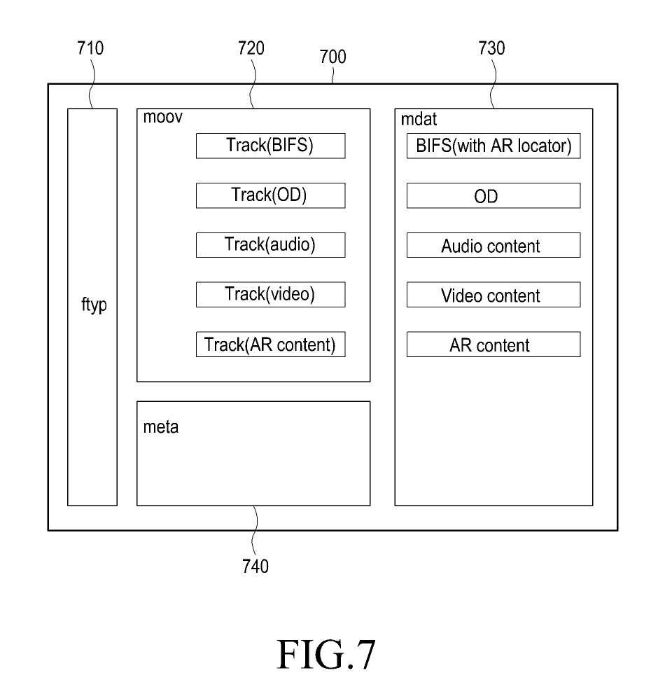

FIG. 7 illustrates an ISO media file format that provides an augmented event for AR according to an exemplary embodiment of the present invention.

Referring to FIG. 7, a media file 700 includes a file type and compatibility (ftyp) box 710, a metadata defining (moov) box 720, a media data (mdat) box 730, and a metadata (meta) box 740. The ftyp box 710 describes a file type and compatibility. A new brand may be defined for an Augmented Reality Application Format (ARAF). The moov box 720 is a container box having sub-boxes (track boxes) that define metadata. A Binary Format for Scene (BIFS) is a scene description scheme that defines the temporal and spatial relationship between audio and visual objects. An object description framework provides a link between an elementary stream and a scene description. The mdat box 730 includes actual media data. A BIFS with an AR locator, an Object Descriptor (OD), and AR content may be stored in this box. The meta box 740 includes annotated metadata. An AR-related description may also be included in this box.

At this point it should be noted that the exemplary embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the exemplary embodiments of the present invention as described above. Alternatively, one or more processors operating in accordance with stored instructions may implement the functions associated with the exemplary embodiments of the present invention as described above. If such is the case, it is within the scope of the present disclosure that such instructions may be stored on one or more processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present invention can be easily construed by programmers skilled in the art to which the present invention pertains

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of providing a media file for an Augmented Reality (AR) service, the method comprising:
storing a media file including information about an event to provide the AR service; and
providing the media file,
wherein the information about the event includes identification information about an event item and information about an event type.

2. The method of claim 1, wherein, if a basic item and the event item are stored in the same file, the identification information about the event item is an Identifier (ID) of the event item.

3. The method of claim 1, wherein, if a basic item and the event item are stored in different files, the identification information about the event item is an index used to search for the event item.

4. The method of claim 1, wherein the information about the event type has one value selected from values indicating ‘replace’ and ‘combine’, ‘replace’ meaning a replacement of a basic item with the event item, and ‘combine’ meaning a displaying of the basic item and the event item together.

5. The method of claim 1, wherein the information about the event further includes an event name and an event description.

6. The method of claim 1, wherein the media file includes a file header area, a metadata area, and a media data area, and
wherein the information about the event is stored in the metadata area.

7. An apparatus of providing a media file for an Augmented Reality (AR) service, the apparatus comprising:
a memory configured to store a media file including information about an event to provide the AR service; and
a controller configured to provide the media file,
wherein the information about the event includes identification information about an event item and information about an event type.

8. The apparatus of claim 7, wherein, if a basic item and the event item are stored in the same file, the identification information about the event item is an Identifier (ID) of the event item.

9. The apparatus of claim 7, wherein, if a basic item and the event item are stored in different files, the identification information about the event item is an index used to search for the event item.

10. The apparatus of claim 7, wherein the information about the event type has one value selected from values indicating ‘replace’ and ‘combine’, ‘replace’ meaning a replacement of a basic item with the event item, and ‘combine’ meaning a displaying of the basic item and the event item together.

11. The apparatus of claim 7, wherein the information about the event further includes an event name and an event description.

12. The apparatus of claim 7, wherein the media file includes a file header area, a metadata area, and a media data area, and
wherein the information about the event is stored in the metadata area.

13. A method of processing a media file for an Augmented Reality (AR) service, the method comprising:
analyzing a media file including information about an event to provide the AR service;
generating image data needed for image reproduction and reproducing the image data by extracting video or audio data from the media file; and
extracting event information from the media file, upon selection of the event, extracting an event item based on identification information about the item and information about an event type included in the event information, configuring an event image corresponding to the event item, combining the event image with the image data, and reproducing the combination.

14. The method of claim 13, wherein, if the identification information about the event item is an Identifier (ID) of the event item, the event item is extracted from a file that stores the image data.

15. The method of claim 13, wherein if the identification information about the event item is an index of a reference file, the event item is extracted from the reference file other than a file that stores the image data.

16. The method of claim 13, wherein, if the information about the event type is ‘replace’, the event image is displayed substituting for the image data.

17. The method of claim 13, wherein, if the information about the event type is ‘combine’, the image data is displayed together with the event image.

18. The method of claim 13, wherein the media file includes a file header area, a metadata area, and a media data area, and
wherein the information about the event is stored in the metadata area.

19. An apparatus of processing a media file for Augmented Reality (AR) service, the apparatus comprising:
a media file analyzer configured to analyze a media file including information about an event to provide the AR service;
a video player configured to generate image data needed for image reproduction and reproduce the image data by extracting video or audio data from the media file;
an event player configured to extract event information from the media file, upon selection of the event, extract an event item based on identification information about the item and information about an event type included in the event information, and generate event image data corresponding to the event item; and
an image combiner configured to combine the image data and the event image data and reproduce the combination, depending on whether the event is selected.

20. The apparatus of claim 19, wherein, if the identification information about the event item is an Identifier (ID) of the event item, the event player extracts the event item from a file that stores the image data.

21. The apparatus of claim 19, wherein, if the identification information about the event item is an index of a reference file, the event player extracts the event item from the reference file other than a file that stores the image data.

22. The apparatus of claim 19, wherein, if the information about the event type is ‘replace’, the event player displays the event image by replacing the image data with the event image.

23. The apparatus of claim 19, wherein, if the information about the event type is ‘combine’, the image combiner displays the image data together with the event image.

24. The apparatus of claim 19, wherein the media file includes a file header area, a metadata area, and a media data area, and
wherein the information about the event is stored in the metadata area.

25. At least one non-transitory processor readable medium for storing a computer program of instructions configured to be readable by at least one processor for instructing the at least one processor to execute a computer process for performing the method as recited in claim 1.
